(19) United States
(12) Patent Application Publication
(10) Pub. No.: US 2021/0365582 A1
(43) Pub. Date: Nov. 25, 2021

(54) Method for Protecting Privacy of Shared Video Files

(71) Applicants: Meir Dahan, Adi (IL); Eliahu Antopolsky, Zichron Yaakov (IL)

(72) Inventors: Meir Dahan, Adi (IL); Eliahu Antopolsky, Zichron Yaakov (IL)

(21) Appl. No.: 16/879,759

(22) Filed: May 21, 2020

(51) Int. Cl. G06F 21/62; H04N 21/472; G06F 16/955

(52) U.S. Cl. CPC G06F 21/6245; G06F 16/955; H04N 21/47202

(57) ABSTRACT

A method for protecting privacy of shared video files that is performed by processing devices running on mobile devices of a first user and a second user and a remote server that enables the users to create a virtual group with a shared dialog box, to store solely on the remote server files of video films that the first user shoots by his mobile device, to display on the shared dialog box links to these files, to enable the second user to select for viewing these links, to stream and playing the video films on the screen of the mobile device of the second user, to prevent the ability of the mobile device to make a screenshot when playing the videos, to prevent abilities of the mobile device of the second user to save, to share or to forward these files.

### TECHNICAL FIELD

The present invention refers to a method for managing and protecting privacy of shared video files mainly that were taken by a mobile device.

### Background Art

Many users of mobile devices like to send to each other photos, video files or audio files. Sometimes the user wants to send to his or her contact such a file that contains sensitive information that the user would prefer that the contact will be unable to save the file, to forward it and to make a screenshot of the photo or the video. In addition, users of mobile devices are afraid to take pictures or to make videos of certain situations because they know that the files of these photos and videos are saved on the mobile device and third person can see them, even if they delete the files from the phone, and hackers may access their mobile and expose those files. The present invention provides a solution for this problem.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a block diagram that shows the mobile device of the first user (100), the mobile device of the second user (200) and the remote server (300), each one of them with a processing device (10).

### THE INVENTION

The term “mobile device” refers to any kind of mobile device, smartphone, tablet or a computer that is designed to have an internet connection and a camera. The term “processing device” refers to a processing device on a server or on the mobile devices, or both.

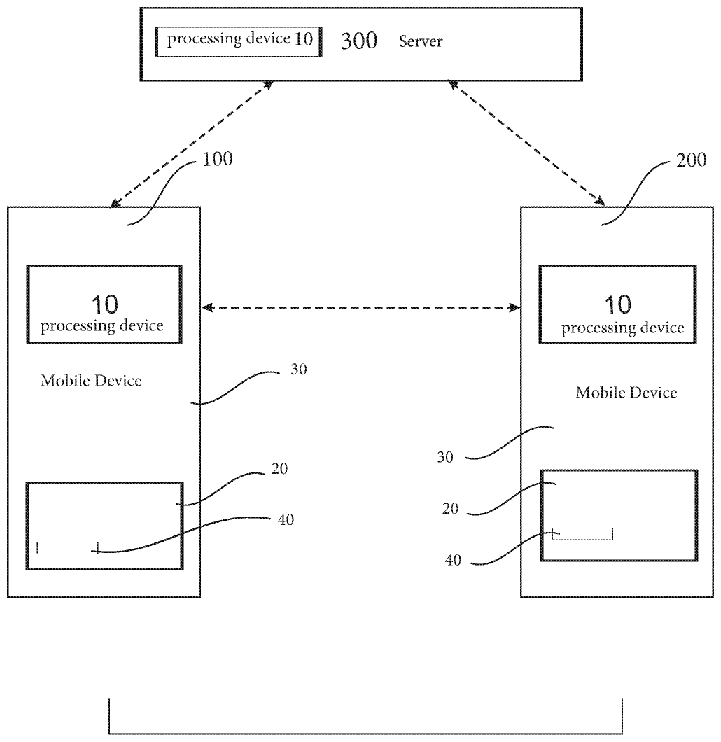

The main object of the present invention is to provide a method for managing and protecting privacy of shared video files that is performed by processing devices (10) running on a mobile device (100) of a first user, on a mobile device (200) of a second user or on a remote server (300). It is possible to implement the present invention to several kinds of files, such as files of video films, files of audio recordings and photographs files, and the term “video film” hereinafter and in the claims refers to video films, photos and audio recordings, and the term “shooting” means also taking or recording. FIG. 1 depicts schematically the mobile device of the first user (100), the mobile device of the second user (200) and the remote server (300), each one of them with a processing device (10).

The method subject matter of the present invention may be executed by a software application, such as a smartphone application, that may include one or more of the following features:

(a) The method enables the first user and the second user to create a virtual group with a shared dialog box (20) that is designed to be displayed on screens (30) of the mobile devices (100) and (200) of the first and the second users. For example, it is possible that the first user will find the second user in the software application by a code or his or her phone number, as it is for example in Telegram™, WhatsApp™ and the like.

(b) The first user can open the software application on his mobile device and take a photo, shoot a video or record an audio by employing the camera and the recording system of his mobile device. It is possible that when the first user open the software application on the screen of his mobile device he will see relevant icons such as “photo” “video” “voice” for taking a photo, for shooting a video and for voice recording. Then, the software application stores the file of the video film that the first user shoots by his mobile device solely and only on the remote server (300). In this way, the first user feels safe and knows that if someone will steal his mobile device then the thief can't see the files and the video film, due to the fact that the files are not stored in the mobile device itself. Note, that it is possible that to enter the software application form the mobile device of the user will require a password.

(c) The method displays on the shared dialog box (20) a link (40) to the file, which is stored on the remote server (300). The first user can view the video film, possible simply by pressing or touching the link and he may delete the link when he wishes to do so. It is possible that the link will be not only in the shared dialog box of the first user with his contact, means the second user, but also in a private library on his mobile device that include links of such video films that the first user may take from time to time, and in this way the first user may delete the link form the shared dialog box with his contact but to keep the link in his private library for future viewing.

(d) The method enables the second user to select for viewing the link that is displayed on the shared dialog box. This may be possible for example simply buy pressing or touching the link on the screen.

(e) The method streams the video film from the server to the mobile device of the second user and plays it on the screen of the mobile device of the second user upon executing the selection for viewing as explained above. It is possible that the method may include a feature so that the video film can be streamed and played on the screen of the mobile device of the second user only when the first user is online and in the shared dialog box, and by that the first user can make sure that the second user may watch the video film only in times that the first user agree and can control. But, it is possible that the method will able an option that the second user will have the ability to watch the vide film as long as the link is still in their shared dialog box, and in anyway the first user can delete this link whenever he wants.

(f) The method prevents the ability of the mobile device of the second user to make a screenshot when playing the video film on its screen, and by that the first user knows that the video film is safer. Indeed, the second user may make a photo of his mobile device by another camera, but this is a risk that the first user may take when the sensitivity of the video film is important but not extremely high.

(g) The method prevents the abilities of the mobile device of the second user to save the file, to share the file or to forward the file to another people. This is a part of making the first user to feel surer that his video film will not be saved and distributed.

(h) The method may also provide to the first user an option to set the file in a free mode or in a conjointly mode. Thus, upon setting the file in the conjointly mode, the method enables to display the link on the shared dialog box or enables the streaming and playing of the video film on the screen of the mobile device of the second user only when the first user is online or is online and in the shared dialog box. Or, upon setting the file in the free mode, the method enables to stream and play the video film on the mobile device of the second user, also when the first user is offline.

The first user can shoot a video that is not going to be saved on his mobile device but only in the remote server, to put a link in the shared dialog box with his contact (second user), and enable the second user to watch the video, knowing that the contact cannot save the file nor forward it, and the first user can at any time delete the link from the shared dialog box, and by that disabling the second user from watching the video again. This method allows users to transfer files more securely to one another.

The second version of the method, which is narrower, may include the ability to shoot the video film by employing the existing camera and voice recording means of the mobile device of the user and storing solely on the remote server the file of the video film that the user shoots by his mobile device, displaying on the screen of the mobile device the link to the file that is stored on the remote server, and enabling the user to select for viewing the link and playing the video film on the screen of the mobile device. In this way, the user may take photos, videos or make voice recordings and he feel safe that in case someone will steal his mobile device that person cannot view these files.

What is claimed is:

1. A method for protecting privacy of shared video files that is performed by processing devices running on a mobile device of a first user, on a mobile device of a second user or on a remote server, comprising:
(a) enabling the first user and the second user to create a virtual group with a shared dialog box that is designed to be displayed on screens of said mobile devices;
(b) storing solely on the remote server a file of a video film that the first user shoots by his mobile device;
(c) displaying on the shared dialog box a link to the file that is stored on the remote server;
(d) enabling the second user to select for viewing the link that is displayed on the shared dialog box;
(e) streaming the video film to the mobile device of the second user and playing it on the screen of the mobile device of the second user upon executing the selection for viewing;
(f) preventing an ability of the mobile device of the second user to make a screenshot when playing the video film on its screen;
(g) preventing abilities of the mobile device of the second user to save the file, to share the file or to forward the file.

2. The method for protecting privacy of shared video files according to claim 1, wherein said streaming and said playing of the video film on the screen of the mobile device of the second user is enabled only when the first user is online and in the shared dialog box.

3. The method for protecting privacy of shared video files according to claim 1, further comprising;
(a) providing said first user with an option to set said file in a free mode or in a conjointly mode;
(b) upon setting the file in said conjointly mode, enabling said display of said link on the shared dialog box or enabling said streaming and said playing of said video film on the screen of the mobile device of the second user, only when the first user is online or is online and in the shared dialog box.
(c) upon setting the file in said free mode, enabling said streaming and said playing of said video film on the screen of the mobile device of the second user, also when the first user is not online.

4. A method for protecting privacy of video files that is performed by processing devices running on a mobile device of a user or on a remote server, comprising:
(a) storing solely on the remote server a file of a video film that the user shoots by his mobile device;
(b) displaying on the screen of the mobile device a link to the file that is stored on the remote server;
(c) enabling the user to select for viewing said link and playing the video film on the screen of the mobile device upon executing the selection for viewing.
